(19) United States
(12) Patent Application Publication
(10) Pub. No.: US 2006/0155573 A1
(43) Pub. Date: Jul. 13, 2006

(54) Method and system for secure information brokering

(76) Inventor: Alfred Hartunian, Burbank, CA (US)

Correspondence Address: CHAN LAW GROUP LC, 1055 W. 7TH ST,, SUITE 1880, LOS ANGELES, CA, 90017, US

(21) Appl. No.: 11/331,800

(22) Filed: Jan. 13, 2006

Related U.S. Application Data
(60) Provisional application No. 60/643,496, filed on Jan. 13, 2005.

(51) Int. Cl. G06Q 99/00

(52) U.S. Cl. 705/1

(57) ABSTRACT

Secure information brokering according to the present disclosure provides a technique for a potential tenant seeking to rent or to lease real estate to have their credit and identity information verified by a secure information broker. The secure information broker may then provide the verified information to the property owner or manager of the real estate as well as to other service or commodity providers. This technique expedites the real estate rental or lease application process, preserves the potential tenant's credit score, and exposes the potential tenant to other services available based on the credit score. This process may also be used to engage any or all of the service or commodity providers ancillary to any real estate transaction.

### CROSS-REFERENCE TO RELATED APPLICATIONS

This is a non-provisional application based on and claiming the priority filing date of co-pending provisional patent application Ser. No. 60/643496, filed Jan. 13, 2005.

### BACKGROUND OF THE INVENTION

1. Field of the Invention

This disclosure relates to real estate property transactions, and more specifically to real estate transactions involving an applicant's request to purchase, rent, lease, or occupy a property, wherein the applicant is required to disclose personal or confidential information to secure credit, qualify for a rental or leased property, and secure services to the rental, leased, or purchased property.

2. Description of the Prior Art

Conventional real estate transactions, whether purchase, rent, lease, or other occupancy, involve verification of credit and identity to accomplish the transaction, which is again repeated with each individual service providers and product lenders such as gas, water, electricity, cable tv, moving aids and others. Completion of a rental property transaction may result in a tenant's credit showing numerous inquiries from a single change of residence. Because credit reporting agencies treat a credit inquiry as a credit event, each inquiry may lower the tenant's credit score therefore increasing the tenant's interest rate and making other transactions unrelated to the real estate transaction more difficult or occasionally impossible.

Property owners may use low cost technology and access to the internet for efficient operation of rental property. This may involve such things as making promotional materials about the property, selecting an acception or rejection criteria, having each potential tenant complete a rent or lease application form, and paying all or part of the cost of a credit or background check. A credit or background check may be purchased from one or more suitable credit reporting agencies or through one of many online intermediaries that sell a manipulated version with or without other types of information.

Each potential tenant customarily completes a rental or lease application form and provides confidential information in response to a series of questions. Included in the rental or lease application is a set of terms and conditions, one of which gives the landlord or its agent the right to access credit and other information. The potential tenant commonly signs the application.

Most commonly, authorized credit reporting agencies such as Equifax, Experian, and Trans-union, are sources used to obtain reliable credit information about an applicant. Aside from offering a specific package designed for tenant screening purposes directly to property operators, credit reporting agencies wholesale credit and identity information to intermediaries that also offer tenant screening services to property operators.

The information is generally relayed verbally or by facsimile to a credit reporting agency, or the information may be entered on a web-based form.

Governing law mandates credit reporting agencies inform the consumer that an authorized requester with a permissible purpose has requested credit information of the consumer. To comply with this law, credit reporting agencies catalog detailed information about the request, and then list an abbreviated version, in a dedicated section of the credit file. The process is also referred to as adding a credit inquiry to a credit file. Credit inquiries also help credit reporting agencies to parse credit records into marketing lists that are sold to marketers for the purpose of providing solicited or unsolicited offers to potential, new occupants. To be excluded, a consumer must make special efforts to opt-out of such marketing lists by making a direct request to each of the credit reporting agencies. The credit reporting agencies are then required to remove the consumer's information from marketing lists, within a reasonable time, after receiving and processing the request.

Credit reporting agencies that use credit scoring systems to formulate a credit score do not reveal the details of such a formulation. Many times, credit reporting agencies treat a credit information request as a credit event, and consider each credit information request when formulating a credit score. Therefore, a number of credit information requests such as those that may occur when a person applies for rental or lease of a property and for the utilities connected to that property may cumulatively have a negative impact upon the person's credit rating.

Usually a potential occupant's social and financial background and income dictate whether the property owner approves or denies the request for occupancy and whether a proposed tenant is required to pay a security deposit.

After being approved for occupancy, one or more of the new occupants, depending on their relationship and needs, activates new services to the property such as utilities, telephone service, and cable.

To establish new services, a new occupant must conduct research to find the types of services offered in the local area and contact each of the suppliers providing the services. The new occupant then arranges for the start of a new service, which may require providing personal information and allowing the service provider access to the new occupant's credit history, and depending upon the credit history, providing a security deposit.

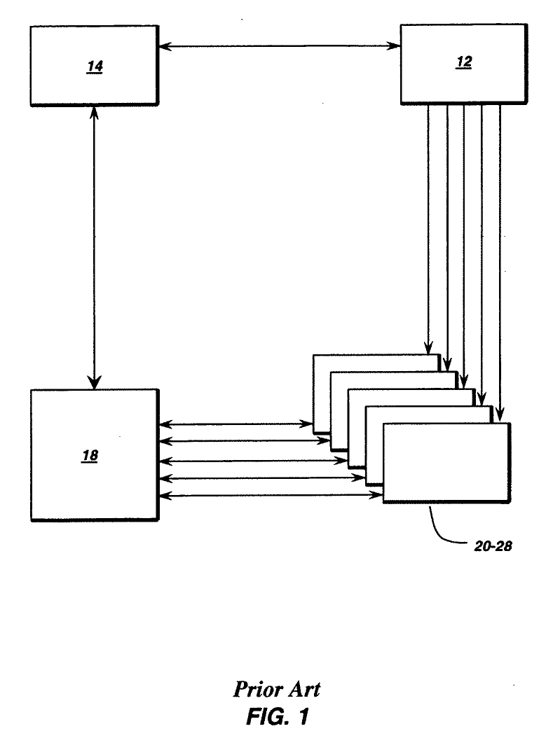

Referring now to FIG. 1, a block diagram shows the communications flow in the above described rental or lease transaction. The potential tenant 12 applies for a rental or lease with a property owner or manager 14 who may request credit and background information from one or more credit reporting agencies 18. Upon approval of the credit and background check, the property owner 14 approves application of the potential tenants 12 who then requests service from each of the service providers 20-28 for gas, electricity, telephone, cable, etc. Each of the service providers 20-28 may request its own credit check from credit reporting agencies. Therefore, the act of moving to a new residence or office may generate many credit inquiries, each of which may be a credit event negatively impacting the potential tenant's credit rating.

A potential tenant may be requested to provide a name, previous address, social security number, identification or driver license number, and date of birth to the service provider. Also, the potential tenant may request service providers to mail notices and bills to a different mailing address than the address at which the service is provided. Often, the data is provided to representatives of the service provider, and in cases of larger service providers, the representatives may be individuals often located in foreign countries.

Because a potential tenant may need to contact many service providers when renting or leasing, the new occupant may provide personal information to many different individuals, some located in foreign countries whose national laws do not offer the same protection regarding the security of personal information as does the United States. Therefore, a potential tenant may have a concern that his or her private information may be misused for fraudulent purposes.

What is needed is a secure method of brokering credit and identity information to all parties related to a real estate transaction to expedite the transaction and to protect the credit and identity of incoming users to the transaction, thereby minimizing negative credit impacts to the potential tenant, and limit the number of individuals receiving confidential information.

### SUMMARY OF THE INVENTION

Although the invention is described for the purpose of applying and qualifying for rental or leased residential property, the invention is equally applicable for purchasing residential or commercial property or the rental or lease of commercial property.

In a first aspect, a secure information broker (SIB) according to the present disclosure provides a technique for a potential tenant to have credit and identity information verified by a secure information broker. The SIB will query commercial and public databases for the potential tenant's credit and personal information. The SIB may then provide the verified information to the property owner or manager as well as service or commodity providers such as: water, electricity power, and natural gas utilities, waste disposal, alarm monitoring renter, insurance, cable television, dial-up internet, high-speed internet, temporary storage facilities, housekeeping, lawn care, or local telephone and long-distance telephone services. Other suitable service or commodity providers may also be served using the disclosed technique. Therefore, the potential tenant's credit report is queried only once.

This technique expedites the rental qualification process, preserves the potential tenant's credit score, shields the potential tenant's personal information, and provides the proposed tenant with offers for other services available based on the credit score. This process may also be used to engage any or all of the service or commodity providers ancillary to any rental or lease.

This technique may be offered to the potential tenant without cost due to the availability of commission fees from service or commodity providers offsetting necessary expenses and possibly providing incentives to the property owner or manager to use the technique of the present disclosure.

Before renting or leasing real property, a potential tenant may consider whether the potential landlord offers a secure application service, especially whether services offered by the SIB will offer rebates to offset, wholly or in part, the credit check fee customarily associated with qualifying for a lease. Such offered services may include activating applicable property services without a credit check, either with or without security deposits, or applying for a credit line useful for paying move-in costs and moving expenses.

An additional aspect of the invention is the ability for the SIB to offer program discounts by participating vendors and to have the discounts automatically applied to or deducted from the total amount of a purchase from the participating vendor. If the potential tenant agrees to use the SIB's secure application service, application data is securely stored for a specific period of time, within which upon the potential tenant's request, the stored data can be transferred onto one of many rent or lease application formats used by many rental property organizations. Further, the data may be viewed on a monitor attached to a computer or wireless device, or printed to a local or remote printer as a paper form. A potential tenant may sign-up for any of the services by entering data on a secured web-page.

The SIB may offer additional services such as, but not limited to, the following:

CONCURRENT UTILITY SERVICE TRANSER: Automatic transfer of critical services such as water, electricity power, and natural gas, from a seller or former tenant of a property to a new buyer or tenant of a property, by a pre-specified date.

UTILITY CREDIT LINE: Establish a new designated credit line to be used for the specific purpose of paying the total amount of one month's household utility bill or paying for the related utility bill deposits. The credit line is to be repaid in smaller monthly payments over an extended period of time. Rebates from SIB to potential tenant may be applied to or deducted from utility charges.

CERTIFIED OR INSURED SERVICE OR PRODUCT REQUEST: Communicate and certify the validity of a request for services or products to a provider. The request further contains verified information related to the identified requester.

NEW ADDRESS/IDENTIFIER: Generate a unique code that comprises other coded items, such as public assessor's unique identifier for a real property, postal mailing address of a property, including a number that identifies a specific unit within the same property, and a unique identifier that identifies each of the adult occupants of the property.

A further aspect of the invention discloses a technique to benefit the potential tenant or user in providing sensitive identity and background data to various service or commodity providers over secure lines in the form of an electronic file ID in order to obtain such services or commodities from the respective providers in connection with a real estate transaction. This technique safeguards the user in that the user will be aware at all times whether an unauthorized party is ever using that user's electronic file ID in any transaction.

These and other features and advantages of this disclosure will become further apparent from the detailed description and accompanying figures that follow. In the figures and description, numerals indicate the various features of the disclosure, like numerals referring to like features throughout both the drawings and the description.

### BRIEF DESCRIPTION OF THE INVENTION

FIG. 1 is a block diagram of a prior art real estate transaction.

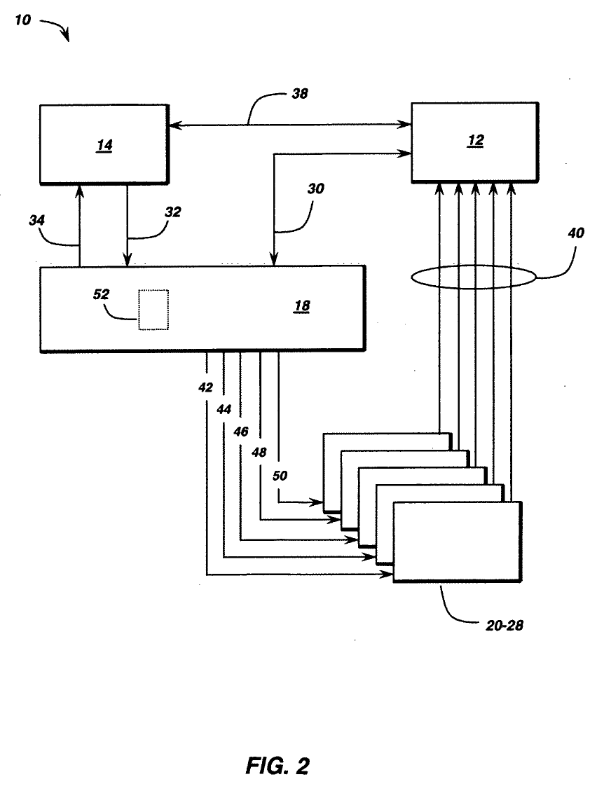

FIG. 2 is a block diagram of a credit and identity brokering technique according to the present disclosure.

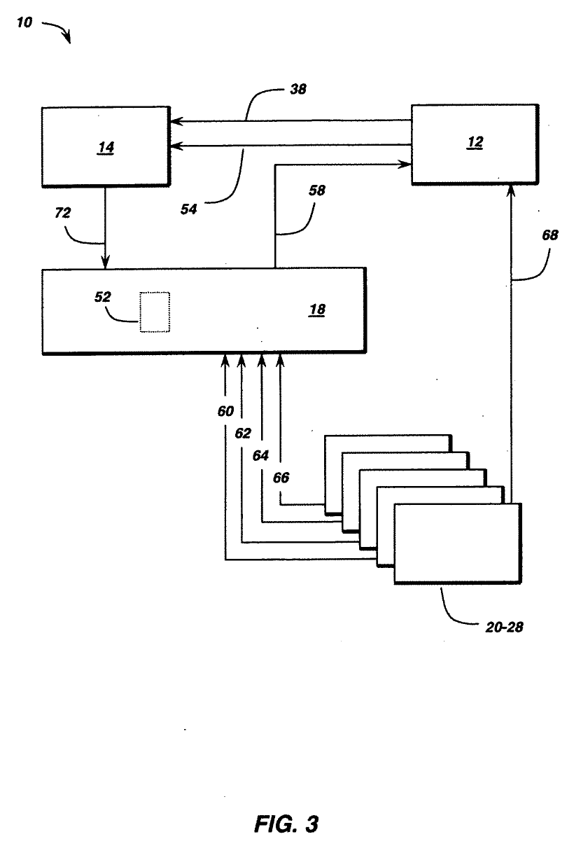

FIG. 3 is a block diagram of a credit and identity brokering technique of FIG. 2 showing the costs and compensations.

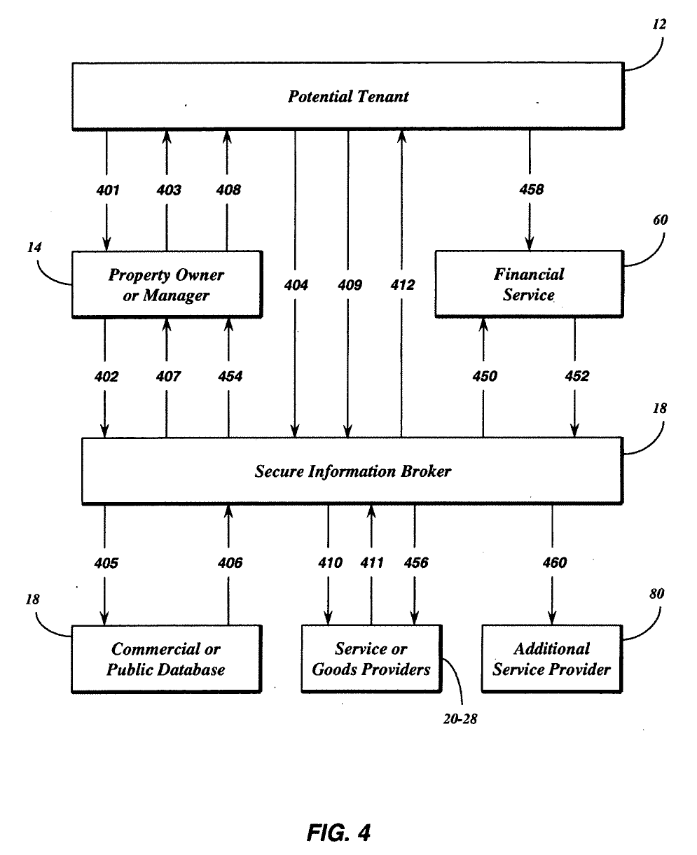

FIG. 4 is a flow diagram showing the communication steps of the secure information broker system.

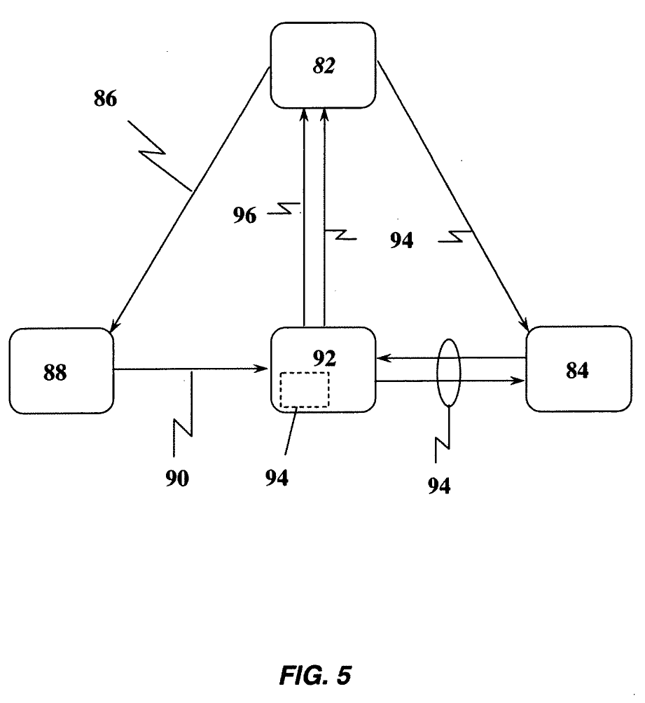

FIG. 5 is a block diagram of a technique involving the secure transmission of a user's identity and background data to a secondary provider according to the present disclosure.

### DETAILED DESCRIPTION OF THE PREFERRED EMBODIMENT(S)

Referring now to FIG. 2, secured information brokering system 10 may be used to enable negotiation 38 between a property owner or manager 14 and a potential tenant 12 as well as services or goods 40 from providers such as providers 20, 22, 24, 26, and 28. In practice, the property owner 14 may request credit and identity verification of the potential tenant 12 using request 32. Secured information broker (SIB) 18 may perform credit and identity verification 36. Verified information 52 may then be provided as verification 34 to the property owner 14. According to the present disclosure, verified information 52 may also be provided as verified data such as data 42, 44, 46, 48, and 50 to providers such as providers 20, 22, 24, 26, and 28 respectively, thus limiting credit inquiries regarding the potential tenant 12 to only credit and identity verification 36.

The potential tenant 12 may be provided a list of services to whom verified data 52 may be transmitted, and the potential tenant 12 may request verified information 52 be provided to providers such as providers 20, 22, 24, 26, and 28 as part of request 32 or as a separate request 30.

Referring now to FIG. 3, as part of negotiation 38 the potential tenant 12 may be required to pay an application fee 54 to property owner 14. Fee 54 may be retained by the property owner 14 as revenue or be used to offset expenses. Property owner 14 may provide a fee 72 to SIB 18 for providing verified data. SIB 18 may receive compensation 60, 62, 64, and 66 in the form of referral fees from providers such as providers 20, 22, 24, and 26 respectively, for providing verified credit and identity data as previously discussed. Exemplary of service or commodity providers 20-26 include water, electricity power, and natural gas utilities, waste disposal, alarm monitoring renter, insurance, cable television, dial-up internet, high-speed internet, temporary storage facilities,.housekeeping, lawn care, or local telephone and long-distance telephone services. SIB 18 may provide cash or service credit 58 to the potential tenant 12 from a portion of compensation 60, 62, 64, and 66. Alternatively, service or commodity providers such as service provider 28 may directly compensate the potential tenant 12 with cash or service credit 68, which may be all or part of the cash or service credit the service provider would have compensated SIB.

Referring now to FIG. 4, the communicative steps to operate the secure SIB are listed below. The listing of steps is not inclusive and may be modified to suit a particular application without affecting the intent of the invention.

In step 401, the potential tenant 12 makes an application to the property owner or manager 14 to rent or lease a particular property. The property owner 14 makes an initial assessment of the application and requests the SIB 18, step 402, to provide authorization and access to the SIB 18 for the potential tenant 12. Upon confirmation, the property owner 14 advises the potential tenant 12, step 403, who then has access to the SIB website for entering confidential data, step 404.

The SIB 18 will request information, step 405, concerning the potential tenant 12 from a variety of commercial and public databases 18 according to the information requested by the property owner 14. The information regarding the potential tenant 12 is received, step 406, compiled, evaluated, and stored within the SIB 18. The SIB 18 prepares and sends a report and a completed rental or lease application, step 407, to the property owner 14 for acceptance or rejection. If the property owner 14 accepts the completed application, the completed application is sent to the potential tenant 12 for signing, step 408.

The potential tenant 12 may now select services from a list of services associated with the particular property. Typically, the services comprise utilities such as electric, gas, telephone, and cable as well as ancillary services related to the particular property location that may be of interest to the potential tenant such as temporary storage facilities, renter insurance, and house keeping services. In addition, local vendors or service providers may wish to present “welcome to the neighborhood” offers or introductory specials for their goods or services. Further, the list of services may include providers responsive to particular items in the potential tenant's 12 credit record or background check. The potential tenant 12 would make his or her selections by communicating directly with the SIB 18, step 409, in any appropriate manner including the use of the SIB 18 website.

In response to the potential tenant's selections, the SIB 18 will transmit, step 410, selected personal data and credit rating to the service providers 20-28 that require such data. To other goods or services providers, the SIB 18 will transmit the potential tenant's desire to make use of their services or to receive “welcome to the neighborhood” offers. Upon receiving confirmation of acceptance and start dates from the service providers 20-28, step 411, the SIB 18 provides notification, step 412, to the potential tenant.

As part of the notification to the potential tenant 12, the SIB 18 may disclose certain information that arises in conducting database searches for credit and background information. One example of such information is whether an inquiry has been made concerning the potential tenant. If the inquiry was not made by or authorized by the potential tenant, then the inquiry may be a result of misuse or fraudulent use of the potential tenant's personal and confidential information.

A further aspect of the invention is that the potential tenant 12 may use his or her confidential data to apply to a financial service 60, step 450, for a line of credit for use in providing funds for security deposits and the like. If approved, the finance service 60 would provide funds to the SIB 18, step 452, for disbursement to the property owner as a security deposit, step 454, and to the service providers 20-28 as security deposits and start-up expenses, step 456. The potential tenant 12 would repay the line of credit directly to the financial service 60, step 458.

An additional aspect of the invention is the potential tenant's 12 confidential data and credit rating may be stored on the SIB 18 for a period of time, and at the potential tenant's 12 option may be provided, step 460, to one or more additional service providers 80. In this manner, the potential tenant 12 may provide his or her confidential data and credit rating to others who may require such data without negatively impacting the potential tenant's 12 credit rating. For example, while shopping for a new car, the potential tenant 12 may visit several dealers, each who may require such data to provide the best price on car financing. Without this additional aspect of the invention, the potential tenant would incur a credit event each time a dealer requested the potential tenant's credit rating from a credit reporting agency, thereby adversely affecting his or her credit rating.

Referring now to FIG. 5, in an alternative embodiment of the disclosure, a technique is disclosed that benefits the potential tenant or user 82 in providing sensitive identity and background data to a secondary provider 84 over secure lines when applying for services or commodities in connection with a real estate transaction. The user 82 initially provides his or her respective identity and background data to a primary provider 86 over unsecured lines, such as verbally by phone, or facsimile. The primary provider 86 in turn submits a request 90 to a suitable commercial data source 92 to obtain confidential data or identity and background verification on the user.

The confidential data of the user is abstracted by the commercial data source 92. The abstracted confidential data includes selected data items from credit history reports and background reports of the user 82 responsive to the request 90. The commercial data source 92 stores the abstracted confidential data of the user 82 in the form of an electronic file ID 94. The electronic file ID 94 of the user 82 is exchanged between the commercial data source 92 and a secondary provider 84 for services or commodities.

The commercial data source 92 transmits to the user 82 the electronic file ID 94 of the user. The commercial data source 92 also sends notification 96 to the potential tenant or user 82 of the user's confidential data responsive to request 90. The user 82 in turn may transmit the electronic file ID 94 over secure lines via the Internet when applying for a service or commodity from a secondary provider 84.

Having now completed this disclosure in accordance with the requirements of the patent statutes, those skilled in this art will understand how to make changes and modifications to the present disclosure to meet their specific requirements or conditions. Such changes and modifications may be made without departing from the scope and spirit of the disclosure as set forth in the following claims.

What is claimed is:

1. A method for providing secure information comprising:
receiving a first request to obtain confidential data from a user;
obtaining the confidential data responsive to the first request;
providing the user with a list of service providers;
receiving a second request from the user to provide confidential data to a plurality of service providers selected from the list of service providers;
abstracting the confidential data responsive to the second request;
storing the abstracted confidential data in a secure information broker; and
providing the abstracted confidential data stored in the secure information broker responsive to the second request, wherein providing further comprises transmitting the abstracted confidential data to the plurality of service providers that are selected responsive to the second request.

2. The method of claim 1 further comprising:
providing a notification to the user responsive to the confidential data.

3. The method of claim 2 further comprising:
selecting a data subset from the confidential data.

4. The method of claim 3, wherein selecting a data subset is responsive to the confidential data.

5. The method of claim 2, wherein the notification comprises the confidential data.

6. The method of claim 2, wherein the notification comprises the abstracted confidential data.

7. The method of claim 1 further comprising:
performing credit and identity verification of the user using an information service.

8. The method of claim 7, wherein the information service conducts verification of the credit and identity of the user for a property principal and a property service principal.

9. The method of claim 7, wherein a request for services and commodities is insured to include the verified credit and identity of the user.

10. A system for providing secure information comprising:
a secure information broker for receiving a first request for confidential data from a user; and
an abstract of confidential data stored within the secure information broker,
wherein the secure information broker transmits a query requesting confidential data from commercial and public databases;
wherein the secure information broker provides the user with a list of service providers for selecting a plurality of service providers;
wherein the secure information broker receives a second request to provide the abstract of confidential data to the plurality of service providers; and
wherein, the secure information broker receives credit history reports and background verification checks from the commercial and public databases;
wherein the abstract comprises selected data items from the credit history reports and background reports responsive to the second request.

11. The system of claim 10, wherein the secure information broker provides a notification to the user responsive to the confidential data.

12. A method for providing secure information comprising:
providing identity and background data of a user to a primary provider;
submitting a request to a data source to obtain confidential data of a user from the primary provider;
abstracting the confidential data of the user responsive to the request;
storing the abstracted confidential data of the user as an electronic file ID;
exchanging the electronic file ID of the user with a secondary provider for identity and background data;
providing the user with the electronic file ID of the user; and
providing the electronic file ID of the user to the secondary provider.

13. The method of claim 12, wherein the abstracted confidential data comprises selected data items from credit history reports and background reports responsive to the request.

14. The method of claim 12 further comprising:
providing a notification to the user responsive to the confidential data.

15. The method of claim 14, wherein the notification comprises a report of the confidential data.
